(19) United States
(12) Patent Application Publication
(10) Pub. No.: US 2005/0272839 A1
(43) Pub. Date: Dec. 8, 2005

(54) Compression-granulated flame retardant composition

(75) Inventors: Harald Bauer, Kerpen (DE); Sebastian Hoerold, Diedorf (DE); Bernd Nass, Augsburg (DE); Martin Sicken, Koeln (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant GmbH

(21) Appl. No.: 11/143,059

(22) Filed: Jun. 2, 2005

(30) Foreign Application Priority Data
Jun. 2, 2004 (DE) 102004026799.5-43

(51) Int. Cl. C08K 5/34

(52) U.S. Cl. 524/115

(57) ABSTRACT

The present invention relates to a compression-granulated flame retardant composition which comprises a phosphinic salt of the formula (I) and/or comprises a diphosphinic salt of the formula (II), and/or comprises their polymers, 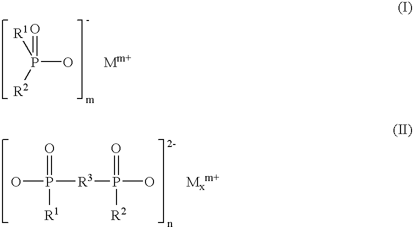 where
R¹ and R² are identical or different and are C₁-C₆-alkyl, linear or branched, and/or aryl; R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Ce, Bi, Sr, Mn, Li, Na, K, and/or a protonated nitrogen base; m is from 1 to 4; n is from 1 to 4; x is from 1 to 4, and comprises a fusible zinc phosphinate; and to a process for preparation of this compression-granulated flame retardant composition, and to the use of the composition.

The present invention relates to a compression-granulated flame retardant composition, and also to a process for preparation of this compression-granulated flame retardant composition, and to the use of the composition.

Organophosphorus compounds are used as flame retardants for plastics, e.g. polyamides or polyesters. The production process for these organophosphorus flame retardants, for example to EP-A-1 047 700 or DE-A-199 10 232, produces them in powder form. The powder form is disadvantageous in many cases, because the tendency to dusting is increased, as is the tendency to cause dust explosions, and incorporation into polymer formulations is rendered more difficult, because bulk density is too low and sometimes because the pulverulent solid is poorly wetted by the polymer.

EP-A-1 396 523 describes a compacted flame retardant composition. Here, a pulverulent flame retardant composition is preferably roller-compacted. The pulverulent flame retardant composition is composed of an organophosphorus flame retardant component and of a compacting aid.

Compacting aids are preferably those from the groups of alkyl ethoxylates, glycols, caprolactam, triphenyl phosphate, waxes, and synthetic resins.

Pulverulent (not compression-granulated) flame retardant compositions have the disadvantage of low particle size and/or bulk density.

A particle size below the preferred range makes incorporation more difficult as a result of increased dust content and explosion risk.

A particle size of the prior art above the inventively preferred range makes uniform dispersion of the organophosphorus flame retardant more difficult. This becomes apparent in poor mechanical strength values (e.g. modulus of elasticity, tensile strength), and also in inadequate flame retardancy.

The object of a compression-granulated flame retardant composition with low dust content alone can be achieved by the prior art. However, a disadvantage of the prior art is that the proposed compacting aids themselves either have no flame-retardant action or make only a very small contribution thereto, because phosphorus content is comparatively low.

An object was therefore to provide a compression-granulated flame retardant composition with increased phosphorus content. This object is achieved by compression-granulating a pulverulent (di)phosphinic salt of the formula (I) and/or (II), and/or their polymers, and a fusible zinc phosphinate, if appropriate with addition of a synergist.

The invention therefore provides a compression-granulated flame retardant composition, which comprises a phosphinic salt of the formula (I) and/or comprises a diphosphinic salt of the formula (II), and/or comprises their polymers, 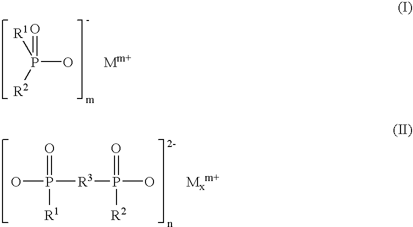
where
R¹ and R² are identical or different and are C₁-C₆-alkyl, linear or branched, and/or aryl;
R³ is C₁-C₁₀-alkylene, linear or branched, C₆-C₁₀-arylene, -alkylarylene, or -arylalkylene;
M is Mg, Ca, Al, Sb, Sn, Ge, Ti, Fe, Zr, Ce, Bi, Sr, Mn, Li, Na, K, and/or a protonated nitrogen base;
m is from 1 to 4;
n is from 1 to 4;
x is from 1 to 4,
   and comprises a fusible zinc phosphinate.

Surprisingly, it has been found that flame-retardant polymer moldings produced with the inventive compression-granulated flame retardant composition have improved flame retardancy. Surprisingly, it has also been found that these inventive flame-retardant polymer moldings have improved mechanical strength values (e.g. modulus of elasticity and tensile strength).

M is preferably calcium, aluminum, or titanium.

Among nitrogen bases in the protonated form, those preferred are the protonated forms of ammonia, melamine, or triethanolamine, in particular NH₄⁺.

Among nitrogen bases in the protonated form, preference is given to the protonated forms of acetoguanamine, acetyleneurea, 1-adamantanamine, alkylguanidine, allantoin, 2-amino-4-methylpyrimidine, ammelides, ammelines, aniline, benzoguanamine, benzotriazole, benzylurea, biguanide, biuret, butyroguanamines, caprinoguanamines, dicyandiamide, dimethylurea, diphenylguanidine, N,N′-diphenylurea, 5,5-diphenylhydantoin, dodecylguanidines, N-(2-aminoethyl)-1,2-ethanediamine, ethylenebis-5-triazone, ethylenedimelamine, N-ethylpiperidine, glycine anhydride, glycoluril, guanidine, urea, hydantoin, malonamide amidine, melamine, 2-phenylbenzimidazole, 1-phenylbiguanide, phenylguanidine, tetramethoxymethylbenzoguanamines, tetramethylguanidine, tetramethylurea, tolyltriazole, triethanolamine, and/or condensates of melamine, e.g. melem, melam, or melon, or higher-condensation-level compounds of this type.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl, and/or phenyl.

R³ is particularly preferably methylene, ethylene, n-propylene, isopropylene, n-butylene, tert-butylene, n-pentylene, n-octylene, or n-dodecylene.

R³ is also particularly preferably phenylene or naphthylene.

R³ is also particularly preferably methylphenylene, ethylphenylene, tert-butylphenylene, methylnaphthylene, ethylnaphthylene, or tert-butylnaphthylene.

R³ is also particularly preferably phenylmethylene, phenylethylene, phenylpropylene, or phenylbutylene.

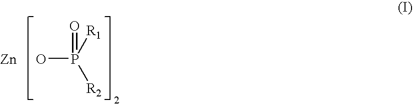

The fusible zinc phosphinates have the formula (I) and/or correspond to its polymers, where R¹ and R² are identical or different and are hydrogen, C₁-C₁₈-alkyl, linear or branched, and/or aryl, and have a melting point of from 40 to 250° C.

R¹ and R², identical or different, are preferably C₁-C₆-alkyl, linear or branched, and/or phenyl.

R¹ and R², identical or different, are particularly preferably methyl, ethyl, n-propyl, isopropyl, n-butyl, tert-butyl, n-pentyl, and/or phenyl.

The zinc phosphinate is particularly preferably zinc dimethylphosphinate, zinc methylethylphosphinate, zinc diphenylphosphinate, or zinc diethylphosphinate. Zinc ethylbutylphosphinate and zinc dibutylphosphinate are also suitable.

The phosphorus content of preferred fusible zinc phosphinate is from 10 to 35% by weight, particularly preferably from 15 to 25% by weight.

The fusible compound zinc diethylphosphinate, which according to the invention can be used with particularly good effect, itself has flame-retardant effect. Its phosphorus content, about 20% by weight, is moreover twice as high as that of, by way of example, triphenyl phosphate (9.5%) which is mentioned in the prior art.

The compression-granulated flame retardant composition may also comprise, alongside the inventive pulverulent (di)phosphinic salt of the formula (I) and/or (II), and/or their polymers, and alongside the fusible zinc phosphinate, at least one synergist.

A preferred synergist according to the invention is melamine phosphate (e.g. ®Melapur MP from Ciba-DSM Melapur), dimelamine phosphate, pentamelamine triphosphate, trimelamine diphosphate, tetrakismelamine triphosphate, hexakismelamine pentaphosphate, melamine diphosphate, melamine tetraphosphate, melamine pyrophosphate (e.g. ®Budit 311 from Budenheim, ®MPP-B from Sanwa Chemicals), melamine polyphosphates, melam polyphosphates, melem polyphosphates, and/or melon polyphosphates. Particular preference is given to melamine polyphosphates, such as ®Melapur 200/70 from Ciba-DSM Melapur, ®Budit 3141, 3141 CA, and 3141 CB, and melamine polyphosphate/melamine pyrophosphate grades 13-1100, 13-1105, 13-1115, and MPP02-244 from Hummel-Croton, and PMP-200 from Nissan.

Other preferred synergists are melamine condensates, such as melam, melem, and/or melon.

Preferred synergists in another embodiment are condensates of melamine, or are reaction products of melamine with phosphoric acid or are reaction products of condensates of melamine with phosphoric acid, or else are a mixture of the products mentioned. Examples of condensates of melamine are melem, melam, or melon, or higher-condensation-level compounds of this type, and also mixtures of these, and can be prepared, by way of example, via a process described in WO-A-96/16948.

The reaction products with phosphoric acid are compounds produced via reaction of melamine or of the condensed melamine compounds, such as melam, melem, or melon, etc., with phosphoric acid. Examples of these are melamine polyphosphate, melam polyphosphate, and melem polyphosphate, and mixed polysalts as described by way of example in WO-A-98/39306. The compounds mentioned have been disclosed previously in the literature and can also be prepared via processes other than direct reaction with phosphoric acid. By way of example, melamine polyphosphate may be prepared by analogy with WO-A-98/45364 via the reaction of polyphosphoric acid and melamine, or by analogy with WO-A-98/08898 via the condensation of melamine phosphate or melamine pyrophosphate.

Further preference is given according to the invention to synergists which are oligomeric esters of tris(hydroxyethyl)isocyanurate with aromatic polycarboxylic acids, tris(hydroxyethyl) isocyanurate, melamine cyanurate (e.g. ®Melapur MC or ®Melapur MC XL from Ciba-DSM Melapur), and/or nitrogen bases in their unprotonated forms.

Further preference according to the invention is given to synergists which are nitrogen-containing phosphates of the formulae (NH₄)_{y}H_{3-y}PO₄ or (NH₄PO₃)_{z}, where y is from 1 to 3, and z is from 1 to 10 000.

The nitrogen compounds are preferably those of the formulae (III) to (VIII) or a mixture thereof 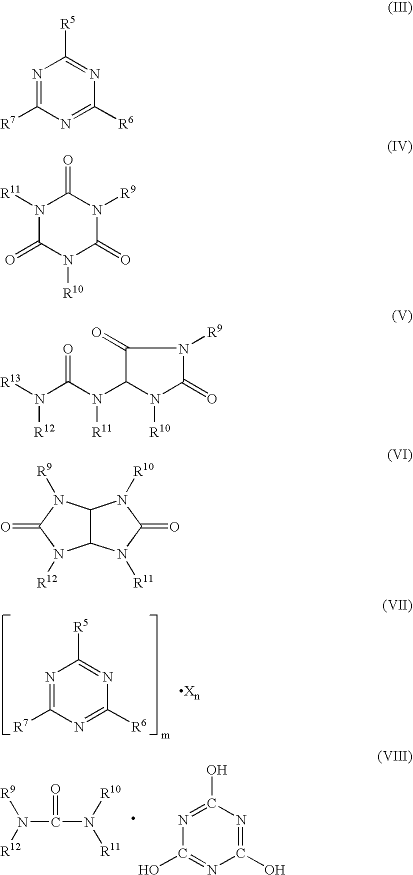
where
R⁵ to R⁷ are hydrogen, C₁-C₈-alkyl, or C₅-C₁₆-cycloalkyl or -alkylcycloalkyl, unsubstituted or substituted with a hydroxy function or with a C₁-C₄-hydroxyalkyl function, or are C₂-C₈-alkenyl, C₁-C₈-alkoxy, -acyl, -acyloxy, C₆-C₁₂-aryl or -arylalkyl, —OR⁸ and —N(R⁸)R⁹, including systems of alicyclic-N or aromatic-N type,
R⁸ is hydrogen, C₁-C₈-alkyl, C₅-C₁₆-cycloalkyl or -alkylcycloalkyl, unsubstituted or substituted with a hydroxy function or with a C₁-C₄-hydroxyalkyl function, or is C₂-C₈-alkenyl, C₁-C₈-alkoxy, -acyl, -acyloxy, or C₆-C₁₂-aryl or -arylalkyl,
R⁹ to R¹³ are the groups of R⁸, or else —O—R⁸,
m and n, independently of one another, are 1, 2, 3 or 4,
X is acids which can form adducts with triazine compounds (III).

Synergistic combinations of the phosphinates mentioned with certain nitrogen-containing compounds, where these are more effective flame retardants than the phosphinates alone in a wide variety of polymers (DE-A-19614 424 A1, and DE-A-197 34 437 A1, and DE-A-197 37 727 A1), are also inventive.

A preferred synergist also derives from the group of the carbodiimides (e.g. ®Stabaxol P from BASF), polyisocyanates (e.g. ®Basonat HI 100 or ®Vestanat T 1890/100), carbonylbiscaprolactam (Allinco), or styrene-acrylic polymers (®Joncryl ADR-4357 from Johnson).

Other preferred synergists come from the group of the sterically hindered phenols (e.g. Hostanox OSP 1), sterically hindered amine light stabilizers (e.g. Chimasorb 944, Hostavin grades), phosphonite antioxidants (e.g. Sandostab® P-EPQ from Clariant), and release agents (Licomont grades from Clariant).

The synergists are preferably zinc compounds, e.g. zinc oxide (e.g. activated zinc oxide), zinc hydroxide, zinc oxide hydrate, anhydrous zinc carbonate, basic zinc carbonate, zinc hydroxide carbonate, basic zinc carbonate hydrate, (basic) zinc silicate, zinc hexafluorosilicate, zinc stannate zinc magnesium aluminum hydroxide carbonate, zinc hexafluorosilicate hexahydrate, zinc salts of the oxo acids of the third main group, e.g. zinc borate (e.g. ®Firebrake ZB, 415 or 500 from Borax, or ®Storflam ZBA from Storey), zinc salts of the oxo acids of the fourth main group (e.g. zinc stannate, zinc hydroxystannate), zinc salts of the oxo acids of the fifth main group, e.g. zinc phosphate, zinc pyrophosphate, zinc salts of the oxo acids of the transition metals, e.g. zinc chromate(VI) hydroxide (zinc yellow), zinc chromite, zinc molybdate (e.g. ®Kemgard 911B, ®Kemgard 911C from Sherwin-Williams Company), zinc permanganate, zinc molybdate magnesium silicate, or zinc permanganate, or zinc sulfides.

Other preferred synergists are those having organic anions, e.g. zinc salts of mono-, di-, oligo-, or polycarboxylic acids (salts of formic acid (zinc formates), of acetic acid (zinc acetates, zinc acetate dihydrate, Galzin), of trifluoroacetic acid (zinc trifluoroacetate hydrate), zinc propionate, zinc butyrate, zinc valerate, zinc caprylate, zinc oleate, zinc stearate, of oxalic acid (zinc oxalate), of tartaric acid (zinc tartrate), citric acid (tribasic zinc citrate dihydrate), benzoic acid (benzoate), zinc salicylate, lactic acid (zinc lactate, zinc lactate trihydrate), acrylic acid, maleic acid, succinic acid, of amino acids (glyzine), of acidic hydroxy functions (zinc phenolates), zinc para-phenolsulfonate, zinc para-phenolsulfonate hydrate, zinc acetylacetonate hydrate, zinc tannate, zinc dimethyldithiocarbamate, or zinc trifluoromethanesulfonate).

Other preferred synergists are magnesium compounds, e.g. magnesium hydroxide, hydrotalcites, magnesium carbonates, or magnesium calcium carbonates.

Other preferred synergists are aluminum compounds, e.g. aluminum hydroxide or aluminum phosphate.

Other preferred synergists are carbodiimides, N,N′-dicyclohexylcarbodiimide, polyisocyanates, carbonylbiscaprolactam, styrene-acrylic polymers, sterically hindered phenols, sterically hindered amines and light stabilizers, phosphonites, antioxidants, and/or release agents.

The inventive compression-granulated flame retardant composition preferably has an average particle size of from 100 to 2000 μm, particularly preferably from 200 to 1000 μm.

Particle size above the preferred range makes uniform dispersion of the inventive compression-granulated flame retardant composition more difficult, and a particle size below the preferred range makes incorporation more difficult, because there is increased dusting and explosion risk.

If bulk density of a flame retardant composition is below the range preferred according to the invention, the air present in the loose powder material has to be continuously removed during preparation of flame-retardant polymer molding compositions via extrusion. An appropriately slow process of incorporation by mixing is needed to achieve this. The result is correspondingly low outputs of polymer molding compositions. Output can be raised via inventive compression-granulated flame retardant compositions.

The average particle size of the pulverulent (di)phosphinic salt of the formula (I) and/or (II) and/or their polymers used as starting material according to the invention is from 0.1 to 1000 μm, preferably from 1 to 100 μm.

The preferred bulk density of the pulverulent (di)phosphinic salt of the formula (I) and/or (II) and/or their polymers used as starting material according to the invention is from 80 to 800 g/l, particularly preferably from 200 to 700 g/l.

The average particle size of the inventive compression-granulated flame retardant composition is from 100 to 2000 μm, preferably from 200 to 1000 μm.

The bulk density of the inventive compression-granulated flame retardant composition is from 200 to 1500 g/l, preferably from 300 to 1000 g/l.

The dust content (fraction with particle sizes below 20 μm) of preferred inventive compression-granulated flame retardant compositions is from 0.1 to 10% by weight, preferably from 0.5 to 5% by weight.

The preferred residue moisture level of the inventive compression-granulated flame retardant composition is from 0.01 to 10% by weight, particularly preferably from 0.1 to 1%.

Residue moisture levels above the inventively preferred ranges bring about greater polymer degradation.

The preferred solubility in water, and/or in the conventional organic solvents, of the inventive pulverulent (di)phosphinic salts of the formula (I) and/or (II) and/or their polymers is from 0.001 to 10% by weight.

The preferred L color values of the inventive pulverulent (di)phosphinic salts of the formula (I) and/or (II) and/or their polymers is from 85 to 99.9, particularly preferably from 90 to 98. Pulverulent (di)phosphinic salt of the formula (I) and/or (II) and/or their polymers with L values below the inventive range require higher use of white pigment. This impairs the mechanical stability properties of the polymer molding (e.g. modulus of elasticity).

Preferred a color values of the inventive pulverulent (di)phosphinic salts of the formula (I) and/or (II) and/or their polymers are from −4 to +9, particularly preferably from −2 to +6.

Preferred b color values of the inventive pulverulent (di)phosphinic salts of the formula (I) and/or (II) and/or their polymers are from −2 to +6, particularly preferably from −1 to +3.

The color values are stated in the Hunter system (CIE-LAB system, Commission Internationale d'Eclairage). L values range from 0 (black) to 100 (white), a values from −a (green) to +a (red) and b values from −b (blue) to +b (yellow).

Pulverulent (di)phosphinic salts of the formula (I) and/or (II) and/or their polymers with a values or b values outside the inventive range require higher use of white pigment. This impairs the mechanical stability properties of the polymer molding (e.g. modulus of elasticity).

The inventive compression-granulated flame retardant composition preferably comprises:
a) from 50 to 98% by weight of phosphinic salt of the formula (I) and/or a diphosphinic salt of the formula (II) and/or their polymers, and
b) from 2 to 50% by weight of a fusible zinc phosphinate.

The inventive compression-granulated flame retardant composition particularly preferably comprises:
a) from 95 to 60% by weight of phosphinic salt of the formula (I) and/or a diphosphinic salt of the formula (II) and/or their polymers, and
b) from 5 to 40% by weight of a fusible zinc phosphinate.

The inventive compression-granulated flame retardant composition particularly preferably comprises:
a) from 8 to 90% by weight of phosphinic salt of the formula (I) and/or a diphosphinic salt of the formula (II) and/or their polymers, and
b) from 2 to 50% by weight of a fusible zinc phosphinate, and
c) from 8 to 90% by weight of at least one synergist.

The inventive compression-granulated flame retardant composition particularly preferably comprises:
a) from 10 to 85% by weight of phosphinic salt of the formula (I) and/or a diphosphinic salt of the formula (II) and/or their polymers, and
b) from 5 to 40% by weight of a fusible zinc phosphinate, and
c) from 10 to 85% by weight of at least one synergist.

Compression-granulated flame retardant compositions with phosphorus contents below the inventive range cannot achieve the desired UL 94 classification when used in flame-retardant polymer molding compositions and/or in other polymers.

The invention also provides a process for preparation of compression-granulated flame retardant compositions which comprises mixing the pulverulent (di)phosphinic salt of the formula (I) and/or (II) and/or their polymers together with the fusible zinc phosphinate and, if appropriate, with other substances, in particular synergists, at from 50 to 300° C. for from 0.01 to 1 hour, and then compacting the material to give the compression-granulated material.

In other words, the pulverulent (di)phosphinic salt of the formula (I) and/or (II) and/or their polymers is compacted with the fusible zinc phosphinate, using pressures of from 0.1 kN/cm² to 100 kN/cm², preferably from 1 kN/cm² to 60 kN/cm².

The pulverulent (di)phosphinic salt of the formula (I) and/or (II) and/or their polymers and/or the synergist are preferably mixed with the fusible zinc phosphinate and compression-granulated.

One embodiment of the inventive compression-granulated flame retardant composition can be prepared by adding the fusible zinc phosphinate in solid or liquid form to the following material kept in motion in a suitable mixer: organophosphorus flame retardant or a mixture of organophosphorus flame retardant and synergist, and mixing at from 50 to 300° C. for from 0.01 to 1 hour.

Possible suitable mixers are:

Plowshare mixers from Lödige (®M5 or ®M20), Telschig Verfahrenstechnik GmbH, or Minox (®PSM 10 to 10000), rotating-disk mixers from Lödige, (e.g. ®CB30, ®CB Konti-Mischer), Niro (®HEC), Drais/Mannheim (e.g. ®K-TTE4), intensive mixers from Eirich (e.g. ®R02, ®R 12, ®DE 18, ®Evactherm), twin-shaft paddle mixers from Eirich, free-fall mixers from Teischig Verfahrenstechnik GmbH (®WPA6) or Hauf, zig-zag mixers from Niro, conical-screw mixers from Nauta, in which the mix is circulated by a screw, using the Archimedes principle, planetary-gear mixing machines from Hobart, double-cone mixers from TELSCHIG Verfahrenstechnik GmbH, fluidized-bed mixers from Telschig Verfahrenstechnik GmbH, air-jet mixers from Telschig Verfahrenstechnik GmbH, spray mixers from Telschig Verfahrenstechnik GmbH, tumbling or container mixers, for example from Thyssen Henschel Industrietechnik GmbH, fluid mixers from Thyssen Henschel Industrietechnik GmbH, cooling mixers from Papenmeier or Thyssen Henschel Industrietechnik GmbH, Flexomix mixers from Schugi.

The compression-granulation is preferably roller-compaction.

Organophosphorus flame retardants and/or synergists and fusible zinc phosphinate are preferably mixed, roller-compacted, broken, and classified.

Organophosphorus flame retardants and/or synergists and fusible zinc phosphinate are preferably mixed, roller-compacted, broken, and classified, and then coated or dried, or dried and coated.

In roller compaction, the pulverulent starting material is fed between two rollers which draw the material in and compact it. In this process, the solid particles are forced into contact via exposure to external pressure. The primary compactate is a sheet or a molding. If the rolls have a structure it is composed of cigar-shaped crusts, for example.

Since the contact area of the rollers in the roller compacting is not particularly well defined, and neither therefore is the effective pressure, the linear pressure is stated here. This is the force acting per cm of length of the compacting rollers. The linear pressure preferably used in roller compaction is from 1 to 50 kN/cm. It is particularly preferable to use a linear pressure of from 2 to 30 kN/cm during roller compaction. The roller compaction preferably takes place at from 10 to 300° C.

Preferred apparatus for roller compaction are compactors from Hosokawa-Bepex GmbH (®Pharmapaktor), Alexanderwerk (®WP 120×40 V, ®WP 170×120 V, ®WP 200×75 VN, ®WP 300×100 V) and roll presses from Köppern.

Other compacting aids without intrinsic flame-retardant effect can preferably be omitted during the roller compaction process.

Subordinate amounts (from 0.1 to 10%) of other compacting aids without intrinsic flame-retardant effect can preferably also be used during the roller compaction process.

The other compacting aids which may be used according to the invention are preferably alkyl alkoxylates having from 8 to 22 carbon atoms and from 1 to 80 EO units per mole of alcohol. Among the alkyl alkoxylates, those preferably used are ethoxylated alcohols, preferably primary alcohols, preferably having from 8 to 22 carbon atoms and preferably from 1 to 80 EO units per mole of alcohol, the alcohol radical being linear or preferably methyl-branched in the 2-position, or containing a mixture of linear and methyl-branched radicals, as is usually the case in oxo alcohol radicals. Examples among the preferred ethoxylated alcohols are C₁₋₁ alcohols having 3, 5, 7, 8, and 11 EO units, (C₁₂-C₁₅) alcohols having 3, 6, 7, 8, 10, and 13 EO units, (C14-C15) alcohols having 4, 7, and 8 EO units, (C₁₆-C₁₈) alcohols having 8, 11, 15, 20, 25, 50, and 80 EO units, and mixtures of these, e.g. ®Genapol T80, T110, T150, T200, T250, T500, T800 from Clariant GmbH. The degrees of ethoxylation stated are statistical averages, which for a specific product may be a whole number or a fractional number. Alongside these, fatty alcohol EO/PO adducts may also be used.

A preferred compacting aid is caprolactam and/or triphenyl phosphate.

Another preferred compacting aid is ethylene glycol, propylene glycol, and/or butylene glycol, their oligomers and/or polymers, and/or their ethers. Further preference is given to polyethylene glycols H(OCH₂CH₂O)ₙOH with molecular weights of from 500 to 40 000. Particular preference is given to ®PEG 600, 800, 1000, 1500, 2000, 3000, 4000, 6000, 8000, 10000, 12000, 20000, 35000. Further preference is given to polyethylene glycol monoalkyl ether, polyethylene glycol monoallyl ether, polyethylene glycol monovinyl ether.

Another preferred compacting aid is naturally occurring, chemically modified, and/or synthetic waxes; preferably carnauba waxes and montan waxes, montan waxes for plastics processing being lubricants and internal release agents for the processing of polyvinyl chloride, of polyolefins, of polyamide, of polystyrene, of linear polyesters, of thermoplastic polyurethane, of curable molding compositions, and of other plastics. They are downstream products from the refining of crude montan wax, which is obtained via extraction of brown coal. They are long-chain carboxylic acids of chain lengths C₂₈-C₃₂, and their full and partial esters with ethylene glycol, glycerol, butylene glycol, and alkaline earth metal salts of partially hydrolyzed esters, e.g. ®Licowax E, ®Licowax WE 4, and ®Licowax OP.

Polyethylene waxes are suitable for the polymer sector (PVC, rubber, polyolefins), examples being ®Licowax PE 520, ®Licowax PE 810, ®Licowax PE 820, ®Licowax PE 830, ®Licowax PE 840, ®Licomont CaV, ®Licolub WE4, Ceridust 5551.

Other preferred compacting aids are synthethic resins, preferably phenolic resins. Further preference is given to synthetic resins, and these according to DIN 55958 are synthetic resins which are prepared via a polymerization, polyaddition, or polycondensation reaction. Thermosets is a generic term for all of the plastics prepared from curable resins. Among the thermosets are epoxy resins, polyurethanes, phenolic resins, melamine resins, and also unsaturated polyester resins. An example of a preferred phenolic resin is 28391 from Durez.

The solids (crusts) which form are mechanically comminuted via breaking to give grains, which are classified. The result is ideal adjustment of grain size. The classified product (correct-size grains) is the inventive roller-compacted flame retardant composition.

Examples of suitable milling equipment are hammer mills, impact mills, vibratory mills, ball mills, roll mills and floating-roller mills from Neuman & Esser, and air-jet mills, such as those from Hosokawa-Alpine. Sifting and/or sieving processes are used for classification. Examples of sieves which may be used for the sieving process are Allgeier, Rhewum, or Locker sieves.

Grinding aids may be added.

An advantage of this compression-granulated material when compared with a melt agglomerate is that less compacting aid is needed. In melting agglomeration, these aids are also termed binders.

Surprisingly, it has been found that the inventive compression-granulated flame retardant compositions exhibit very good dispersion behavior in the plastic.

Another preferred compression-granulation process is compression to give a continuous strand. The fine-particle starting materials are compacted in matrix systems (2-axial) and in output systems in the form of a continuous strand. This requires a particular range of wall friction angle or of sliding-friction properties. The continuous strand breaks apart without further measures to give cylinders of different length, or chopping knives are used.

A preferred process mixes organophosphorus flame retardant and/or synergists and fusible zinc phosphinate and compresses them to give a continuous strand, and then, if appropriate, dries and/or coats the material.

A preferred process mixes organophosphorus flame retardant and/or synergists and fusible zinc phosphinate and compresses them to give a continuous strand, and breaks and classifies and then, if appropriate, coats the material.

A preferred process mixes organophosphorus flame retardant and/or synergists and fusible zinc phosphinate and compresses them to give a continuous strand, and breaks and classifies and dries the material.

A preferred process mixes organophosphorus flame retardant and/or synergists and fusible zinc phosphinate and compresses them to give a continuous strand, and breaks, classifies, dries and coats the material.

The compression process to give a continuous strand preferably takes place at from 10 to 500° C.

Equipment preferred for this process is granulating presses from Kahl (e.g. ®24-390/500 press), pelletizing presses from Schlüter (®PP 85, PP 127, PP 200, PP 360), the benchtop granulator from Fitzpatrick, twin-screw extruders from Leistritz (®ZSE 27/40/50/60/75/100/135, ZSE 27 HP/40/50/60/75/87), laboratory extruders from Leistritz (®MICRO 18/27), single-screw extruders from Leistritz (®ESE 30/40/50/60/70/80/90/120/150/200), water-cooled die-face granulators, etc., or a circular-action compactor (etch-runner).

In compression to give a continuous strand use may also preferably be made of subordinate amounts (up to 10%) of materials from the group of the compacting aids without intrinsic flame-retardant effect.

Another preferred process is tableting and briquetting, based on the compaction of fine-particle products in matrix systems with 2 rams or in sculpted rolls to give tablets or briquettes.

A preferred process mixes organophosphorus flame retardant and/or synergist and fusible zinc phosphinate, tablets or briquettes, and breaks and classifies, and then, if appropriate, dries and/or coats the material

Preferred equipment for this purpose is cube presses from Bühler (®KUBEX DPGC 900.178, DPGB 900.228), or roll presses from Köppern.

The tableting/briquetting process may also use subordinate amounts (up to 10%) of materials from the group of the compacting aids without intrinsic flame-retardant effect.

The tableting/briquetting process preferably takes place at from 10 to 300° C.

The compression-granulated flame retardant composition may be dried or heat-conditioned in a suitable drier. Possible inventive driers are: fluidized-bed driers from Hosokawa Schugi (Schugi ®Fluid-Bed, ®Vometec fluidized-bed driers), fluidized-bed driers from Waldner or from Glatt, turbo-fluidized-bed driers from Waldner, ®Spin-flash driers from Anhydro, and drum driers.

Preferred operating conditions in the fluidized-bed drier are: air input temperature from 120 to 280° C., product temperature from 20 to 200° C.

The residue moisture level in the inventive compacted flame retardant composition (residual moisture level) is from 0.01 to 10%, preferably from 0.05 to 1%.

The inventive compression-granulated flame retardant composition can optionally also be coated.

Preferred coating compositions are those from the group of the diffusion inhibitors, lubricants, and/or release agents.

The coating process preferably takes place in one of the mixing and/or drying units mentioned, by adding the coating composition and mixing at from 50 to 300° C. for from 0.01 to 1 hour.

The invention also provides a flame-retardant polymer molding composition which comprises the inventive compression-granulated flame retardant composition.

The flame-retardant polymer molding composition preferably comprises
from 1 to 50% by weight of compression-granulated flame retardant composition,
from 1 to 99% by weight of thermoplastic polymer or a mixture of these.
   The flame-retardant polymer molding composition preferably comprises
from 1 to 50% by weight of compression-granulated flame retardant composition,
from 1 to 99% by weight of thermoplastic polymer or a mixture of these,
from 0.1 to 60% by weight of additives,
from 0.1 to 60% by weight of filler or of reinforcing material.

The flame-retardant polymer molding composition particularly preferably comprises
from 5 to 30% by weight of compression-granulated flame retardant composition,
from 5 to 90% by weight of thermoplastic polymer or a mixture of these,
from 5 to 40% by weight of additives,
from 5 to 40% by weight of filler or of reinforcing material.

The preferred residual moisture level of the inventive flame-retardant molding compositions is from 0.01 to 10% by weight, particularly preferably from 0.1 to 1%.

The polymers preferably comprise polymers of mono- and diolefins, for example polypropylene, polyisobutylene, poly-1-butene, poly-4-methyl-1-pentene, polyisoprene, or polybutadiene, and also polymers of cycloolefins, e.g. of cyclopentene or norbornene; also polyethylene (which may, where appropriate, have been crosslinked), e.g. high-density polyethylene (HDPE), high-density high-molecular-weight polyethylene (HMWHDPE), high-density ultra high-molecular-weight polyethylene (UHMWHDPE), medium-density polyethylene (MDPE), low-density polyethylene (LDPE), linear low-density polyethylene (LLDPE), and branched low-density polyethylene (VLDPE) or a mixture thereof.

The polymers preferably comprise copolymers of mono- and diolefins with one another or with other vinyl monomers, e.g. ethylene-propylene copolymers, linear low-density polyethylene (LLDPE), and mixtures of the same with low-density polyethylene (LDPE), propylene-1-butene copolymers, propylene-isobutylene copolymers, ethylene-1-butene copolymers, ethylene-hexene copolymers, ethylene-methylpentene copolymers, ethylene-heptene copolymers, ethylene-octene copolymers, propylene-butadiene copolymers, isobutylene-isoprene copolymers, ethylene-alkyl acrylate copolymers, ethylene-alkyl methacrylate copolymers, ethylene-vinyl acetate copolymers and copolymers of these with carbon monoxide, and ethylene-acrylic acid copolymers and salts of these (ionomers), and also terpolymers of ethylene with propylene and with a diene, such as hexadiene, dicyclopentadiene, or ethylidenenorbornene; also mixtures of these copolymers with one another, e.g. polypropylene/ethylene-propylene copolymers, LDPE/ethylene-vinyl acetate copolymers, LDPE/ethylene-acrylic acid copolymers, LLDPE/ethylene-vinyl acetate copolymers, LLDPE/ethylene-acrylic acid copolymers, and alternating-structure or random-structure polyalkylene-carbon monoxide copolymers, and mixtures of these with other polymers, e.g. with polyamides.

The polymers preferably comprise hydrocarbon resins (e.g. C₅-C₉), inclusive of hydrogenated modifications thereof (e.g. tackifier resins), and mixtures of polyalkylenes and starches.

The polymers preferably comprise polystyrene, poly(p-methylstyrene), poly(alpha-methylstyrene).

The polymers preferably comprise copolymers of styrene or alpha-methylstyrene with dienes or with acrylic derivatives, e.g. styrene-butadiene, styrene-acrylonitrile, styrene-alkyl methacrylate, styrene-butadiene-alkyl acrylate, styrene-butadiene-alkyl methacrylate, styrene-maleic anhydride, styrene-acrylonitrile-methyl acrylate; mixtures with high impact strength made from styrene copolymers with another polymer, e.g. with a polyacrylate, with a diene polymer, or with an ethylene-propylene-diene terpolymer; and block copolymers of styrene, e.g. styrene-butadiene-styrene, styrene-isoprene-styrene, styrene-ethylene/butylene-styrene, and styrene-ethylene/propylene-styrene.

The polymers preferably comprise graft copolymers of styrene or alpha-methylstyrene, e.g. styrene on polybutadiene, styrene on polybutadiene-styrene copolymers, styrene on polybutadiene-acrylonitrile copolymers, styrene and acrylonitrile (and, respectively, methacrylonitrile) on polybutadiene; styrene, acrylonitrile, and methyl methacrylate on polybutadiene; styrene and maleic anhydride on polybutadiene; styrene, acrylonitrile, and maleic anhydride or maleimide on polybutadiene; styrene and maleimide on polybutadiene, styrene and alkyl acrylates and, respectively, alkyl methacrylates on polybutadiene, styrene and acrylonitrile on ethylene-propylene-diene terpolymers, styrene and acrylonitrile on polyalkyl acrylates or on polyalkyl methacrylates, styrene and acrylonitrile on acrylate-butadiene copolymers, and also mixtures of these, e.g. those known as ABS polymers, MBS polymers, ASA polymers, or AES polymers.

The polymers preferably comprise halogen-containing polymers, e.g. polychloroprene, chlorinated rubber, chlorinated and brominated isobutylene-isoprene copolymer (halobutyl rubber), chlorinated or chlorosulfonated polyethylene, copolymers of ethylene with chlorinated ethylene, epichlorohydrin homo- and copolymers, and in particular polymers of halogen-containing vinyl compounds, e.g. polyvinyl chloride, polyvinylidene chloride, polyvinyl fluoride, polyvinylidene fluoride; and copolymers of these, such as vinyl chloride-vinylidene chloride, vinyl chloride-vinyl acetate, and vinylidene chloride-vinyl acetate.

The polymers preferably comprise polymers derived from alpha, beta-unsaturated acids or some derivatives of these, for example polyacrylates and polymethacrylates, butyl-acrylate-impact-modified polymethyl methacrylates, polyacrylamides, and polyacrylonitriles, and copolymers of the monomers mentioned with one another or with other unsaturated monomers, e.g. acrylonitrile-butadiene copolymers, acrylonitrile-alkyl acrylate copolymers, acrylonitrile-alkoxyalkyl acrylate copolymers, acrylonitrile-vinyl halide copolymers, and acrylonitrile-alkyl methacrylate-butadiene terpolymers.

The polymers preferably comprise polymers derived from unsaturated alcohols or amines and, respectively, their acyl derivatives or acetals, for example polyvinyl alcohol, polyvinyl acetate, polyvinyl stearate, polyvinyl benzoate, polyvinyl maleate, polyvinyl butyral, polyallyl phthalate, polyallylmelamine; or copolymers of these with the abovementioned olefins.

The polymers preferably comprise homo- and copolymers of cyclic ethers, e.g. polyalkylene glycols, polyethylene oxide, polypropylene oxide, or copolymers of these with bisglycidyl ethers.

These polymers preferably comprise polyacetals, such as polyoxymethylene, and polyoxymethylenes which contain comonomers, e.g. ethylene oxide; polyacetals modified with thermoplastic polyurethanes, with acrylates, or with MBS.

The polymers preferably comprise polyphenylene oxides or polyphenylene sulfides, or a mixture of these with styrene polymers or with polyamides.

The polymers preferably comprise polyurethanes derived, on the one hand, from polyethers, polyesters, or polybutadienes having terminal hydroxy groups, and, on the other hand, from aliphatic or aromatic polyisocyanates, or else precursors of these polyurethanes.

The polymers preferably comprise polyamides and copolyamides derived from diamines and dicarboxylic acids, and/or from aminocarboxylic acids, or from the corresponding lactams, for example nylon-4, nylon-6, nylon-6,6, -6,10, -6,9, -6,12, -4,6, -12,12, nylon-11, and nylon-12, aromatic polyamides based on m-xylene, diamine and adipic acid; polyamides prepared from hexamethylenediamine and iso- and/or terephthalic acid and, where appropriate, an elastomer as modifier, e.g. poly-2,4,4-trimethylhexamethyleneterephthalamide or poly-m-phenyleneisophthalamide. Other suitable polymers are block copolymers of the abovementioned polyamides with polyolefins, with olefin copolymers, with ionomers, or with chemically bonded or grafted elastomers; or with polyethers, e.g. with polyethylene glycol, polypropylene glycol, or polytetramethylene glycol. EPDM- or ABS-modified polyamides or copolyamides are also suitable, as are polyamides condensed during processing (“RIM polyamide systems”).

The polymers preferably comprise polyureas, polyimides, polyamideimides, polyetherimides, polyesterimides, polyhydantoins, or polybenzimidazoles.

The polymers preferably comprise polyesters derived from dicarboxylic acids and dialcohols and/or from hydroxycarboxylic acids, or from the corresponding lactones, for example polyethylene terephthalate, polybutylene terephthalate, poly-1,4-dimethylolcyclohexane terephthalate, polyhydroxybenzoates, and also block polyetheresters derived from polyethers having hydroxyl end groups; said polyesters modified with polycarbonates or with MBS.

The polymers preferably comprise polycarbonates or polyester carbonates.

The polymers preferably comprise polysulfones, polyether sulfones, or polyether ketones.

The polymers preferably comprise crosslinked polymers derived, on the one hand, and, from aldehydes and, on the other hand, from phenols, urea, or melamine, for example phenol-formaldehyde resins, urea-formaldehyde resins, or melamine-formaldehyde resins.

The polymers preferably comprise drying and non-drying alkyd resins.

The polymers preferably comprise unsaturated polyester resins derived from copolyesters of saturated or unsaturated dicarboxylic acids with polyhydric alcohols, and also vinyl compounds as crosslinking agents, or else halogen-containing, flame-retardant modifications of these.

The polymers preferably comprise crosslinkable acrylic resins derived from substituted acrylic esters, e.g. from epoxyacrylates, from urethane acrylates, or from polyester acrylates.

The polymers preferably comprise alkyd resins, polyester resins, or acrylate resins which have been crosslinked by melamine resins, by urea resins, by isocyanates, by isocyanurates, by polyisocyanates, or by epoxy resins.

The polymers preferably comprise crosslinked epoxy resins derived from aliphatic, cycloaliphatic, heterocyclic, or aromatic glycidyl compounds, e.g. products of bisphenol A diglycidyl ethers or of bisphenol F diglycidyl ethers, which are crosslinked by way of conventional hardeners, e.g. anhydrides or amines, with or without accelerators.

The polymers preferably comprise naturally occuring polymers, such as cellulose, natural rubber, gelatin, and also their polymer-homologously chemically modified derivatives, such as cellulose acetates, cellulose propionates, and cellulose butyrates, and the respective cellulose ethers, such as methylcellulose; and rosins and derivatives.

The polymers preferably comprise mixtures (polyblends) of the abovementioned polymers, e.g. PP/EPDM, nylon/EPDM or ABS, PVC/EVA, PVC/ABS, PVC/MBS, PC/ABS, PBTP/ABS, PC/ASA, PC/PBT, PVC/CPE, PVC/acrylates, POM/thermoplastic PU, PC/thermoplastic PU, POM/acrylate, POM/MBS, PPO/HIPS, PPO/nylon-6,6 and copolymers, PA/HDPE, PA/PP, PA/PPO, PBT/PC/ABS, and PBT/PET/PC.

The invention also provides a process for preparation of flame-retardant polymer molding compositions, which comprises mixing the inventive flame retardant compositions, if appropriate with other additives, and introducing them by way of a side feed into a compounding assembly and homogenizing them at relatively high temperatures in the polymer melt, and then drawing off the homogenized continuous polymer strand and cooling it, dividing it into portions, and/or drying it.

The compounding assembly preferably derives from the group of the single-screw extruders, multisection screws, or twin-screw extruders. The processing temperatures are preferably
from 170 to 200° C. for polystyrene,
from 200 to 300° C. for polypropylene,
from 250 to 290° C. for polyethylene terephthalate (PET),
from 230 to 270° C. for polybutylene terephthalate (PBT),
from 260 to 290° C. for nylon-6,
from 260 to 290° C. for nylon-6,6,
from 280 to 320° C. for polycarbonate.

Screw lengths (L) of the extruder (compounding assembly), in multiples of the screw diameter (D), are preferably from 4 to 200D, preferably from 10 to 50D.

Compounding assemblies which may be used according to the invention are single-screw extruders such as those from Berstorff GmbH, Hanover, and/or from Leistritz, Nuremberg.

Compounding assemblies which may be used according to the invention are multisection-screw extruders with three-section screws and/or short-compression-section screws.

Other compounding assemblies which may be used according to the invention are co-kneaders, e.g. from Coperion Buss Compounding Systems, Pratteln, Switzerland, e.g. ®MDK/E46-11D, and/or laboratory kneaders (®MDK 46 from Buss, Switzerland with L=11D).

Compounding assemblies which may be used according to the invention are twin-screw extruders, e.g. from Coperion Werner & Pfleiderer GmbH & Co. KG, Stuttgart (®ZSK 25, ZSK30, ZSK 40, ZSK 58, ZSK MEGAcompounder 40, 50, 58, 70, 92, 119, 177, 250, 320, 350, 380), and/or from Berstorff GmbH, Hanover, or Leistritz Extrusionstechnik GmbH, Nuremberg.

Compounding assemblies which may be used according to the invention are ring extruders, e.g. from 3+Extruder GmbH, Laufen, with a ring of from three to twelve small screws, rotating around a static core, and/or planetary-gear extruders, e.g. from Entex, Bochum, and/or vented extruders, and/or cascade extruders, and/or Maillefer screws.

Compounding assemblies which may be used according to the invention are compounders with counter-rotating twin screws, e.g. ®Compex 37 or ®Compex 70 from Krauss-Maffei Berstorff.

Effective inventive screw lengths for single-screw extruders are from 20 to 40D.

Effective inventive screw lengths (L) for multisection-screw extruders are 25D, with feed section (L=10D), transition section (L=6D), metering section (L=9D).

Effective inventive screw lengths for twin-screw extruders are from 8 to 48D.

The flame-retardant polymer molding composition is preferably a granulated material (compounded material), which preferably has the shape of a cylinder with a circular, elliptical or irregular base, or of a sphere, cushion, cube, parallelepiped, or prism.

The length:diameter ratio of the granulated material is from 1:50 to 50:1, preferably from 1:5 to 5:1.

The preferred diameter of the granulated material is from 0.5 to 15 mm, particularly preferably from 2 to 3 mm, and its preferred length is from 0.5 to 15 mm, particularly preferably from 2 to 5 mm. The granulated material obtained is, by way of example, dried in an oven with air circulation at 90° C. for 10 h.

Finally, the invention also provides polymer moldings, polymer films, polymer filaments, and polymer fibers, comprising the inventive compression-granulated flame retardant composition.

The polymer of the polymer moldings, of the polymer films, of the polymer filaments, and of the polymer fibers preferably comprises a thermoplastic or thermoset polymer.

The polymer moldings, polymer films, polymer filaments, and polymer fibers preferably comprise
from 1 to 70% by weight of compression-granulated flame retardant composition,
from 1 to 99% by weight of polymer or a mixture of these.

The polymer moldings, polymer films, polymer filaments, and polymer fibers preferably comprise
from 1 to 70% by weight of compression-granulated flame retardant composition,
from 1 to 99% by weight of polymer or a mixture of these,
from 0.1 to 60% by weight of additives,
from 0.1 to 60% by weight of filler or of reinforcing materials.

The polymer moldings, polymer films, polymer filaments, and polymer fibers preferably comprise
from 50 to 99% by weight of flame-retardant polymer molding compositions.

The polymer moldings, polymer films, polymer filaments, and polymer fibers preferably comprise
from 50 to 99% by weight of flame-retardant polymer molding compositions,
from 1 to 50% by weight of polymer or a mixture of these.

The polymer moldings, polymer films, polymer filaments, and polymer fibers preferably comprise
from 50 bis 99% by weight of flame-retardant polymer molding compositions,
from 1 bis 50% by weight of polymer or a mixture of these,
from 0.1 to 60% by weight of additives,
from 0.1 to 60% by weight of filler or of reinforcing materials.

The polymer moldings, polymer films, polymer filaments, and polymer fibers preferably comprise
from 70 to 95% by weight of flame-retardant polymer molding compositions.

The inventive compression-granulated flame retardant composition is preferably used in flame-retardant polymer molding compositions which are then used to produce polymer moldings.

Preferred forms of reinforcing materials for flame-retardant polymer molding compositions and flame-retardant polymer moldings are fibers, nonwovens, mats, textiles, strands, tapes, flexible tubes, braids, solid bodies, moldings, and hollow bodies.

Preferred materials for reinforcing materials for flame-retardant polymer molding compositions and flame-retardant polymer moldings are inorganic materials, such as E glass (aluminum boron silicate glass for general plastics reinforcement and for electrical applications), R glass and S glass (specialty glasses for high mechanical requirements and high temperature), D glass (specialty glass for increased dielectric requirements and high temperature), C glass (alkali-lime glass with increased boron addition for particular chemicals resistance), quartz glass, carbon, minerals, metal (steel, aluminum, magnesium, molybdenum, tungsten), ceramics (metal oxides).

Preferred materials for reinforcing materials for flame-retardant polymer molding compositions and flame-retardant polymer moldings are polycondensates, e.g. nylon-6 (e.g. ®Perlon), nylon-6,6 (e.g. ®Nylon), nylon-11 (e.g. ®Rilsan, ®Qiana), aromatic polyamides (poly-m-phenyleneisophthalamide (e.g. ®Nomex), poly-p-phenyleneterephthalamide (e.g. ®Aramid, ®Kevlar)), polyethylene glycol terephthalate (e.g. ®Dacron, ®Diolen, ®Terylene, ®Trevira, ®Vestan, etc.), poly-1,4-dimethylenecyclohexane terephthalate (e.g. ®Kodel, ®Vestan X 160, etc.), polycarbonate, polyurethane elastomers (e.g. ®Dorlastan, ®Lycra, etc.).

Preferred materials for reinforcing materials for flame-retardant polymer molding compositions and flame-retardant polymer moldings are polymers, e.g. polyethylene, polypropylene, polyacrylonitrile homopolymer, polyacrylonitrile copolymer (e.g. ®Dralon, ®Orlon), modacrylics (e.g. ®Kanekalon, ®Venel), atactic polyvinyl chloride (e.g. ®Rhovyl, ®Fibravyl), syndiotactic polyvinyl chloride (e.g. ®Leavil), polyvinyl alcohol (e.g. ®Kuralon, ®Vinylal, ®Vinylon), polytetrafluoroethylene (e.g. ®Teflon, ®Hostaflon), polystyrene (e.g. ®Polyfiber, ®Styroflex).

Preferred materials for reinforcing materials for flame-retardant polymer molding compositions and flame-retardant polymer moldings are natural and semisynthetic fibers (viscose cellulose, copper cellulose, cellulose acetate, cellulose triacetate, flax, hemp, sisal, jute, ramie, cotton).

Preferred dimensions for short glass fibers are lengths of from 0.01 to 10 mm and diameters of from 0.005 to 0.015 mm.

Addition of glass fibers to polyamides within the inventive concentration ranges leads to a marked rise in strength, stiffness, softening point, abrasion resistance, and dimensional stability.

Preferred additives for flame-retardant polymer molding compositions and flame-retardant polymer moldings are antioxidants (e.g. alkylated monophenols, alkylthiomethylphenols, hydroquinones, and alkylated hydroquinones, hydroxylated thiodiphenyl ethers, alkylidenebisphenols, O-, N-, and S-benzyl compounds, hydroxybenzylated malonates, hydroxybenzyl aromatics, triazine compounds, benzyl phosphonates, acylaminophenols, esters of beta-(3,5-di-tert-butyl-4-hydroxyphenyl)propionic acid with mono- or polyhydric alcohols, esters of beta-(5-tert-butyl-4-hydroxy-3-methylphenyl)propionic acid with mono- or polyhydric alcohols, esters of beta-(3,5-dicyclohexyl-4-hydroxyphenyl)propionic acid with mono- or polyhydric alcohols, esters of 3,5-di-tert-butyl-4-hydroxyphenylacetic acid with mono- or polyhydric alcohols, amides of beta-(3,5-di-tert-butyl-4-hydroxyphenyl)propionic acid, ascorbic acid (vitamin C), aminic antioxidants).

Preferred additives for flame-retardant polymer molding compositions and flame-retardant polymer moldings are UV absorbers, and light stabilizers (2-(2′-hydroxyphenyl)benzotriazoles, 2-hydroxybenzophenones, esters of unsubstituted or substituted benzoic acids, acrylates; nickel complexes of 2,2′-thiobis[4-(1,1,3,3-tetramethylbutyl)phenol], nickel salts of monoalkyl esters of 4-hydroxy-3,5-di-tert-butylbenzylphosphonic acid, nickel complexes of ketoximes, nickel complexes of 1-phenyl-4-lauroyl-5-hydroxypyrazole, where appropriate with additional ligands; sterically hindered amines, oxalamides, 2-(2-hydroxyphenyl)-1,3,5-triazines).

Preferred additives for flame-retardant polymer molding compositions and flame-retardant polymer moldings are lubricants, colorants, antistatic agents, nucleating agents (e.g. inorganic substances, e.g. talc, metal oxides, such as titanium dioxide or magnesium oxide, phosphates, carbonates, or sulfates of, preferably, alkaline earth metals; organic compounds, such as mono- or polycarboxylic acids, or else their salts, e.g. 4-tert-butylbenzoic acid, adipic acid, diphenylacetic acid, sodium succinate, or sodium benzoate; polymeric compounds, e.g. ionic copolymers (“ionomers”)).

Preferred additives for flame-retardant polymer molding compositions and flame-retardant polymer moldings are fillers (e.g. chalk and calcium carbonate, silicates, phyllosilicates, clay minerals, e.g. bentonite, montmorillonite, hectorite, saponite, precipitated/fumed/crystalline/amorphous silicas, glass beads, talc, kaolin, mica, barium sulfate, metal oxides, and metal hydroxides, oxides and/or hydroxides of the elements of the second and third main group of the Periodic Table of the Elements (preferably aluminum and magnesium), carbon black, graphite, wood flour, and flours or fibers derived from other natural products, or synthetic fibers).

The inventive fillers and/or reinforcing materials may have been surface-pretreated with a silane compound to improve compatibility with the thermoplastic.

Suitable silane compounds are those of the general formula
(X—(CH₂)ₙ)ₖ—Si—(O—CₘH₂ₘ₊₁)₂₋ₖ
where the substituents are defined as follows:
n is a whole number from 2 to 10, preferably from 3 to 4
m is a whole number from 1 to 5, preferably from 1 to 2,
k is a whole number from 1 to 3, preferably 1.

Preferred silane compounds are aminopropyltrimethoxysilane, aminobutyltrimethoxysilane, aminopropyltriethoxysilane, aminobutyltriethoxysilane, and the corresponding silanes whose substituent X is a glycidyl group.

The amounts of the silane compounds generally used for surface coating are from 0.05 to 5% by weight, preferably from 0.5 to 1.5% by weight, and in particular from 0.8 to 1% by weight (based on E).

Examples of additives which can be used are stated in EP-A-0 584 567.

Finally, the invention also provides a process for production of flame-retardant polymer moldings, which comprises using injection molding (e.g. an injection-molding machine (Aarburg Allrounder) and compression molding, foam injection molding, internal-gas-pressure injection molding, blow molding, film casting, calendering, lamination, or coating at relatively high temperatures to process inventive flame-retardant polymer molding compositions to give flame-retardant polymer moldings.

This process preferably uses the following processing temperatures
from 200 to 250° C. for polystyrene,
from 200 to 300° C. for polypropylene,
from 250 to 290° C. for polyethylene terephthalate (PET),
from 230 to 270° C. for polybutylene terephthalate (PBT),
from 260 to 290° C. for nylon-6,
from 260 to 290° C. for nylon-6,6,
from 280 to 320° C. for polycarbonate.

Surprisingly, it has been found that the mechanical properties of flame-retardant polymer moldings based on the inventive compression-granulated flame retardant compositions or flame-retardant molding compositions are considerably better than the prior art.

The modulus of elasticity of flame-retardant polymer moldings based on the inventive compression-granulated flame retardant compositions or flame-retardant molding compositions and on polybutylene terephthalate is preferably from 10 000 to 12 000 MPa.

The modulus of elasticity of flame-retardant polymer moldings based on the inventive compression-granulated flame retardant compositions or flame-retardant molding compositions and on nylon-6,6 is preferably from 10 000 to 12 000 MPa.

The modulus of elasticity of flame-retardant polymer moldings based on the inventive compression-granulated flame retardant compositions or flame-retardant molding compositions and on nylon-6 is preferably from 10 000 to 12 000 MPa.

The UL 94 classification of polymer moldings based on the inventive compression-granulated flame retardant compositions or flame-retardant molding compositions is preferably V-1 or V-0.

Flame-retardant coating comprising at least
from 1 to 50% of compacted flame retardant composition,
from 0.1 to 60% of ammonium polyphosphate.

Experimental Section

Grain size distribution determination using a Microtrac granulometer

Particle size in aqueous dispersion is determined with the aid of a Microtrac ASVR/FRA granulometer from Leeds & Northrup. The degree of reflection or scattering of a laser beam is measured as it penetrates the dispersion. For this, 400 ml of ethanol are pumped through the laser measurement cell. The solid specimen (e.g. 70 mg) is metered in automatically, and after 10 min the particle size distribution is determined. The evaluation unit of the equipment calculates the d₅₀ value and the d₉₀ value.

Roller Compaction

In a roller compactor (from the company Hosokawa-Bepex, L200/50P), a feed screw is used to pass the starting material between the compactor rolls (setting: level 2-3). This takes place sufficiently rapidly to generate the desired linear pressure with a contact length of 50 mm. The roll rotation rate is set to level 2, and the roll gap is 0.1 mm. The crusts produced (length: about 50 mm, thickness: about 2-5 mm, width: about 10-15 mm) are broken in a hammer mill (from the company Alpine, UPZ) using a screen aperture diameter of 5 mm with a rotation rate of from 600 to 1400 rpm.

Fractionation of Particles

First, the coarse particles are removed from the broken roller-compacted product on an electrical vibratory sieve (from the company Siemens) with a 1.7 mm sieve installed. From the material which passes the sieve, the undersize particles are removed using a second sieve (400 μm). The material retained on the sieve is the correct-size particles. The coarse particles are returned to breaking and sieving.

Compression to Give Continuous Strand

A Leistritz ®ZSE 27-44 twin-screw extruder is used to obtain dust-free and relatively fracture-resistant cylindrical granules from mixtures of organophosphorus flame retardant and fusible zinc phosphinate, or from a mixture of organophosphorus flame retardant, synergist, and fusible zinc phosphinate, at extrusion temperatures of up to about 200° C., by means of die-face cutting.

Determination of Tendency Toward Dusting

10 g of the material to be studied are weighed into a wash bottle. Nitrogen is passed through the material for 20 min, using a gas flow rate of 1 l/min. The amount of powder remaining after this procedure is weighed. The proportion discharged is divided by the initial weight, and related to 100%.

Preparation, Processing, and Testing of Flame-Retardant Polymer Molding Compositions and Polymer Moldings

The flame-retardant components are mixed with the polymer granules and, where appropriate, with additives, and incorporated in a twin-screw extruder (Leistritz® LSM 30/34) at temperatures of from 230 to 260° C. (GR PBT) and, respectively, from 260 to 280° C. (GR PA 66). The homogenized polymer strand is drawn off, cooled in the waterbath, and then granulated.

After adequate drying, the molding compositions are processed on an injection molding machine (Aarburg Allrounder) at melt temperatures of from 240 to 270° C. (GR PBT) and, respectively, from 260 to 290° C. (GR PA 66) to give test specimens which are tested and classified for flame retardancy, using the UL 94 test (Underwriters Laboratories).

The UL 94 (Underwriters Laboratories) fire classification was determined on test specimens from each mixture, using test specimens of thickness 1.5 mm.

The UL 94 fire classifications are as follows:

V-0: afterflame time never longer than 10 sec, total of afterflame times for 10 flame applications not more than 50 sec, no flaming drops, no complete consumption of the specimen, afterglow time for the specimens never longer than 30 seconds after end of flame application

V-1: afterflame time never longer than 30 sec after end of flame application, total of afterflame times for 10 flame applications not more than 250 sec, afterglow time for these specimens never longer than 60 sec after end of flame application, other criteria as for V-0

V-2: cotton indicator ignited by flaming drops; other criteria as for V-1

Unclassifiable (ucl): does not comply with fire classification V-2.

### EXAMPLES

### Example 1

4.5 kg of pulverulent (di)phosphinic salt of the formula (I) and/or (II) and/or their polymers (average particle diameter d₅₀=42 μm, dust content, i.e. particles of size below 20 μm: 15%), 3.5 kg of melamine polyphosphate, and 2 kg of fusible zinc phosphinate are mixed and compacted in compliance with the general “Roller compaction” specifications using a linear pressure of 2 kN/cm, and processed in compliance with the general “Fractionation of particles” specification to give a fraction of particle size from 400 to 1700 μm, whose dust content, i.e. content of particle size below 20 μm, is less than 1%.

### Example 2

4.5 kg of the same pulverulent (di)phosphinic salt of the formula (I) and/or (II) and/or their polymers as in example 1, 3.5 kg of melamine polyphosphate, and 2 kg of fusible zinc phosphinate are mixed and compacted in compliance with the general “Roller compaction” specifications using a linear pressure of 10 kN/cm, and processed in compliance with the general “Fractionation of particles” specification to give a fraction of particle size from 400 to 1700 μm, whose dust content, i.e. content of particle size below 20 μm, is less than 1%.

### Example 3 (Comparison)

4.5 kg of the same pulverulent (di)phosphinic salt of the formula (I) and/or (II) and/or their polymers as in example 1, 3.5 kg of melamine polyphosphate, and 2 kg of polyethylene glycol are mixed and compacted in compliance with the general “Roller compaction” specifications using a linear pressure of 10 kN/cm, and processed in compliance with the general “Fractionation of particles” specification to give a fraction of particle size from 400 to 1700 μm, whose dust content, i.e. content of particle size below 20 μm, is less than 1%.

### Example 4

4.5 kg of the same pulverulent (di)phosphinic salt of the formula (I) and/or (II) and/or their polymers as in example 1, 3.5 kg of melamine polyphosphate, and 2.00 kg of fusible zinc phosphinate are mixed and compacted in compliance with the general “Roller compaction” specifications using a linear pressure of 30 kN/cm, and processed in compliance with the general “Fractionation of particles” specification to give a fraction of particle size from 400 to 1700 μm, whose dust content, i.e. content of particle size below 20 μm, is less than 1%.

### Example 5 (Comparison)

9.9 kg of melamine polyphosphate and 100 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%. The yield of granulated material is very small, and the phosphorus content of the compression-granulated flame retardant composition is below the inventively preferred range.

### Example 6 (Comparison)

9.9 kg of the same pulverulent (di)phosphinic salt of the formula (I) and/or (II) and/or their polymers as in example 1, and 100 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%. The yield of granulated material is very low.

### Example 7

9 kg of the same pulverulent (di)phosphinic salt of the formula (I) and/or (II) and/or their polymers as in example 1, 800 g of melamine polyphosphate, and 200 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 8

800 g of the same pulverulent (di)phosphinic salt of the formula (I) and/or (II) and/or their polymers as in example 1, 9 kg of melamine polyphosphate, and 200 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 9

8.5 kg of the same pulverulent (di)phosphinic salt of the formula (I) and/or (II) and/or their polymers as in example 1, 1 kg of melamine polyphosphate, and 500 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 10

1 kg of the same pulverulent (di)phosphinic salt of the formula (I) and/or (II) and/or their polymers as in example 1, 8.5 kg of melamine polyphosphate, and 500 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 11

3 kg of the same pulverulent (di)phosphinic salt of the formula (I) and/or (II) and/or their polymers as in example 1, 3 kg of melamine polyphosphate, and 4 kg of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 12

4.5 kg of the same pulverulent (di)phosphinic salt of the formula (I) and/or (II) and/or their polymers as in example 1, 0.5 kg of melamine polyphosphate, and 5 kg of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 13

0.5 kg of the same pulverulent (di)phosphinic salt of the formula (I) and/or (II) and/or their polymers as in example 1, 4.5 kg of melamine polyphosphate, and 5 kg of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 14

9.8 kg of the same pulverulent (di)phosphinic salt of the formula (I) and/or (II) and/or their polymers as in example 1, and 200 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 15

9.5 kg of the same pulverulent (di)phosphinic salt of the formula (I) and/or (II) and/or their polymers as in example 1, and 500 g of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 16

5 kg of the same pulverulent (di)phosphinic salt of the formula (I) and/or (II) and/or their polymers as in example 1, and 5 kg of fusible zinc phosphinate are mixed and compacted in compliance with the general “Roller compaction” specifications using a linear pressure of 10 kN/cm, and are processed in compliance with the general “Fractionation of particles” specification to give a fraction of particle size from 400 to 1700 μm, whose dust content, i.e. particles of size below 20 μm, is less than 1%.

### Example 17

5.33 kg of the same pulverulent (di)phosphinic salt of the formula (I) and/or (II) and/or their polymers as in example 1, 2.67 kg of melamine polyphosphate, and 2 kg of fusible zinc phosphinate are mixed, and dust-free and relatively fracture-resistant cylindrical granules are obtained in compliance with the general “compaction to give a continuous strand” specification.

### Example 18

8 kg of the same pulverulent (di)phosphinic salt of the formula (I) and/or (II) and/or their polymers as in example 1, and 2 kg of fusible zinc phosphinate are mixed, and dust-free and relatively fracture-resistant cylindrical granules are obtained in compliance with the general “Compression to give continuous strand” specification.

### Example 19

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 2 is compounded in a twin-screw extruder to give polymer molding compositions. After drying, the molding compositions are processed at from 260 to 290° C. in an injection-molding machine to give polymer moldings. The elasticity values and strength values for the polymer moldings are good, and the UL 94 classification obtained is V-0. The elasticity values and strength values for the moldings are better than in comparative examples 20 and 21.

### Example 20, Comparison

In compliance with the general specification, a mixture of 53% by weight of nylon-6,6 (®Ultramid A3), 30% by weight of glass fibers (®Vetrotex EC 10 4.5 mm 98A), and 17% by weight of oversize particles of the compression-granulated flame retardant composition from example 2 (fraction of particle size greater than 1700 μm) is compounded in a twin-screw extruder to give-polymer molding compositions. After drying, the molding compositions are processed in an injection-molding machine at from 260 to 290° C. to give polymer moldings. The elasticity values and strength values for the polymer moldings are poorer than those of example 19, as is the UL 94 classification.

### Example 21, Comparison

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 3 is compounded in a twin-screw extruder to give polymer molding compositions. After drying, the molding compositions are processed at from 260 to 290° C. in an injection-molding machine to give polymer moldings. The UL 94 classification obtained using the compression-granulated flame retardant composition is V-2, poorer than in example 19.

### Example 22

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 6 is compounded in a twin-screw extruder to give polymer molding compositions. After drying, the molding compositions are processed at from 260 to 290° C. in an injection-molding machine to give polymer moldings. Although the UL 94 classification obtained is favorable, V-0, and the phosphorus content of the compression-granulated flame retardant composition is within the inventively claimed range, the yield of granulated material is too low.

### Example 23

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 7 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high. The elasticity values and strength values for the moldings are better than in the comparative examples 20 and 21.

### Example 24

In compliance with the general specification, a mixture of 53% by weight of nylon-6,6 ((Ultramid A3), 30% by weight of glass fibers (®Vetrotex EC 10 4.5 mm 98A), and 17% by weight of the compression-granulated flame retardant composition from example 8 is compounded in a twin-screw extruder to give polymer molding compositions. After drying, the molding compositions are processed at from 260 to 290° C. in an injection-molding machine to give polymer moldings. Specifically, the UL 94 classification obtained is adequate, V-1, and the phosphorus content of the compression-granulated flame retardant composition is within the inventively claimed range, and the yield of granulated material is high. The elasticity values and strength values for the moldings are better than in the comparative examples 20 and 21.

### Example 25

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 9 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 26

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 10 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 27

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 11 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 28

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 12 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 29

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 13 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 30

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 14 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

### Example 31

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 15 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high. The elasticity values and strength values for the moldings are better than in the comparative examples 20 and 21.

### Example 32

In compliance with the general specification, a mixture of 53% by weight of nylon-6,6 (®Ultramid A3), 30% by weight of glass fibers (®Vetrotex EC 10 4.5 mm 98A), and 17% by weight of the compression-granulated flame retardant composition from example 16 is compounded in a twin-screw extruder to give polymer molding compositions. After drying, the molding compositions are processed at from 260 to 290° C. in an injection-molding machine to give polymer moldings. Specifically, the UL 94 classification obtained is favorable, V-0, and the phosphorus content of the compression-granulated flame retardant composition is within the inventively claimed range, and the yield of granulated material is high.

Substances Used

Organophosphorus flame retardant: ®Exolit OP 1230, Clariant GmbH, phosphorus content: 23.8% by weight

Synergist: ®Melapur 200/70, Ciba-DSM Melapur, phosphorus content: 13.4% by weight

Fusible zinc phosphinate: ®Exolit OP 950 (TP), Clariant GmbH, phosphorus content 20.2% by weight

Polyethylene glycol: ®PEG 4000 polyethylene glycol, Clariant, phosphorus content: 0% by weight

TABLE 1

| | | | | | | | P content |
|---|---|---|---|---|---|---|---|
| | | | Fusible | | | | (of comp.- |
| | Organophosphorus | | zinc | | Linear | | gran. fl. |
| | flame retardant | Synergist | phosphinate | PEG | pressure | Yield | ret. comp.) |
| Example | % by wt. | % by wt. | % by wt. | % by wt. | kN/cm | % | % by wt. |
| 1 | 45.0 | 35.0 | 20 | | 2 | 54 | 19.5 |
| 2 | 45.0 | 35.0 | 20 | | 10 | 66 | 19.5 |
| 3 | 45.0 | 35.0 | | 20 | 10 | 68 | 15.4 |
| (comp) | | | | | | | |
| 4 | 45.0 | 35.0 | 20 | | 30 | 71 | 19.5 |
| 5 | 0.0 | 99.0 | 1 | | 10 | 32 | 13.5 |
| (comp) | | | | | | | |
| 6 | 99.0 | 0.0 | 1 | | 10 | 35 | 23.8 |
| 7 | 90.0 | 8.0 | 2 | | 10 | 46 | 22.9 |
| 8 | 8.0 | 90.0 | 2 | | 10 | 42 | 14.4 |
| 9 | 85.0 | 10.0 | 5 | | 10 | 56 | 22.6 |
| 10 | 10.0 | 85.0 | 5 | | 10 | 58 | 14.8 |
| 11 | 30.0 | 30.0 | 40 | | 10 | 64 | 19.2 |
| 12 | 45.0 | 5.0 | 50 | | 10 | 66 | 21.5 |
| 13 | 5.0 | 45.0 | 50 | | 10 | 60 | 17.3 |
| 14 | 98 | 0 | 2 | | 10 | 48 | 23.8 |
| 16 | 95 | 0 | 5 | | 10 | 53 | 23.7 |
| 16 | 50.0 | 0.0 | 50 | | 10 | 70 | 22.0 |

TABLE 2

| | Compression- | | | UL 94 |
|---|---|---|---|---|
| | granulated | Modulus of | Tensile | classi- |
| | flame retardant | elasticity | strength | fication |
| Example | composition | [MPa] | [N/mm2] | (0.8 mm) |
| 19 | Example 2 | 9300 | 176 | V-0 |
| 20 (comp) | Example 2 | 7900 | 60 | V-1 |
| | oversize particles | | | |
| 21 (comp) | Example 3 | | | V-2 |
| | (comp) | | | |
| 22 | Example 6 | 8600 | 120 | V-0 |
| 23 | Example 7 | 8600 | 110 | V-0 |
| 24 | Example 8 | | | V-1 |
| 25 | Example 9 | | | V-0 |
| 26 | Example 10 | | | V-0 |
| 27 | Example 11 | | | V-0 |
| 28 | Example 12 | | | V-0 |
| 29 | Example 13 | | | V-0 |
| 30 | Example 14 | | | V-0 |
| 31 | Example 15 | 8800 | 126 | V-0 |
| 32 | Example 16 | | | V-0 |

1. A compression-granulated flame retardant composition, comprising a phosphinic salt of the formula (I), a diphosphinic salt of the formula (II), a polymer of the phosphinic salt, a polymer of the diphosphinic salt or a mixture thereof, 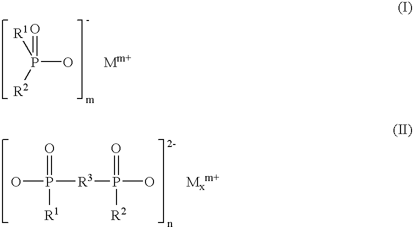
where
R¹ and R² are identical or different and are C₁-C₆-alkyl, linear or branched, or aryl; R³ is C₁-C₁₀-alkylene, linear or branched, C₆-C₁₀-arylene, -alkylarylene, or -arylalkylene; M is Mg, Ca, Al, Sb, Sn, Ge, Ti, Fe, Zr, Ce, Bi, Sr, Mn, Li, Na, K, or a protonated nitrogen base; m is from 1 to 4; n is from 1 to 4; x is from 1 to 4, and
at least one fusible zinc compound selected from the group consisting of a fusible zinc phosphinate, a polymer of a fusible zinc phosphinate and a mixture thereof.

2. The compression-granulated flame retardant composition as claimed in claim 1, wherein M is calcium, aluminum, or titanium.

3. The compression-granulated flame retardant composition as claimed in claim 1, wherein R¹ and R² are identical or different and are C₁-C₆-alkyl, linear or branched, or phenyl.

4. The compression-granulated flame retardant composition as claimed in claim 1, wherein R¹ and R² are identical or different and are methyl, ethyl, n-propyl, isopropyl, n-butyl, tert-butyl, n-pentyl, or phenyl.

5. The compression-granulated flame retardant composition as claimed in claim 1, wherein R³ is methylene, ethylene, n-propylene, isopropylene, n-butylene, tert-butylene, n-pentylene, n-octylene, n-dodecylene; phenylene, naphthylene; methylphenylene, ethylphenylene, tert-butylphenylene, methylnaphthylene, ethylnaphthylene, tert-butylnaphthylene; phenylmethylene, phenylethylene, phenylpropylene, or phenyl-butylene.

6. The compression-granulated flame retardant composition as claimed in claim 1, wherein the fusible zinc phosphinate and the polymer of the fusible zinc phosphinate are of the formula (I) 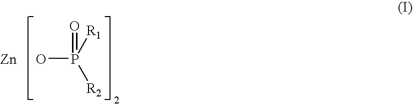
where R¹ and R² are identical or different and are hydrogen, C₁-C₁₈-alkyl, linear or branched, or aryl, and have a melting point of from 40 to 250° C.

7. The compression-granulated flame retardant composition as claimed in claim 6, wherein R¹ and R² are identical or different and are C₁-C₆-alkyl, linear or branched, or phenyl.

8. The compression-granulated flame retardant composition as claimed in claim 6, wherein R¹ and R² are identical or different and are methyl, ethyl, n-propyl, isopropyl, n-butyl, tert-butyl, n-pentyl, or phenyl.

9. The compression-granulated flame retardant composition as claimed in claim 1, wherein the at least one fusible zinc compound is zinc dimethylphosphinate, zinc methylethylphosphinate, zinc diphenylphosphinate, or zinc diethylphosphinate.

10. The compression-granulated flame retardant composition as claimed in claim 1, wherein the at least one fusible zinc compound has a phosphorus content of from 10 to 35% by weight.

11. The compression-granulated flame retardant composition as claimed in claim 1, further comprising at least one synergist.

12. The compression-granulated flame retardant composition as claimed in claim 11, wherein the at least one synergist is melamine phosphate, dimelamine phosphate, melamine pyrophosphate, melamine polyphosphates, melam polyphosphates, melem polyphosphates, melon polyphosphates; melamine condensates, oligomeric esters of tris(hydroxyethyl) isocyanurate with aromatic polycarboxylic acids, benzoguanamine, tris(hydroxyethyl) isocyanurate, allantoin, glycoluril, melamine, melamine cyanurate, dicyandiamide, or guanidine.

13. The compression-granulated flame retardant composition as claimed in claim 11, wherein the at least one synergist is a nitrogen-containing phosphate of the formulae (NH₄)_{y}H_{3-y}PO₄ or (NH₄PO₃)_{z}, where y is from 1 to 3 and z is from 1 to 10 000.

14. The compression-granulated flame retardant composition as claimed in claim 11, wherein the at least one synergist is a nitrogen compound of the formulae (III) to (VIII), or a mixture thereof 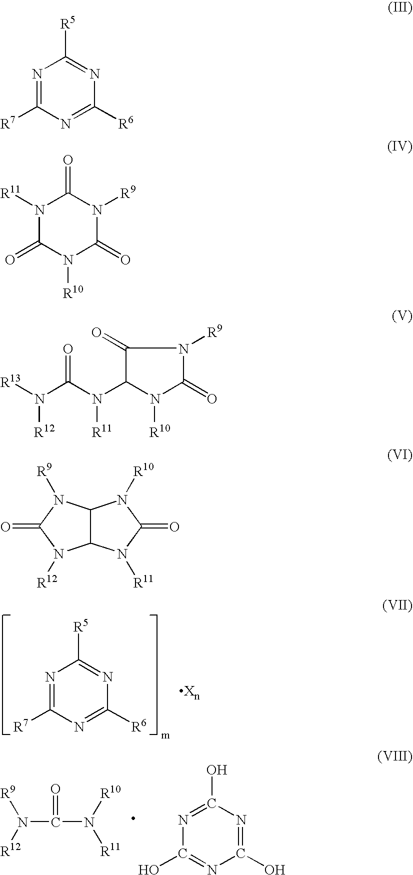
where
R⁵ to R⁷ are hydrogen, C₁-C₈-alkyl, C₅-C₁₆-cycloalkyl or -alkylcycloalkyl, unsubstituted or substituted with a hydroxy function or with a C₁-C₄-hydroxyalkyl function, C₂-C₈-alkenyl, C₁-C₈-alkoxy, -acyl, -acyloxy, C₆-C₁₂-aryl or -arylalkyl, —OR⁸ and —N(R⁸)R⁹, including systems of alicyclic-N or aromatic-N type,
R⁸ is hydrogen, C₁-C₈-alkyl, C₅-C₁₆-cycloalkyl or -alkylcycloalkyl, unsubstituted or substituted with a hydroxy function or with a C₁-C₄-hydroxyalkyl function, C₂-C₈-alkenyl, C₁-C₈-alkoxy, -acyl, -acyloxy, or C₆-C₁₂-aryl or -arylalkyl,
R⁹ to R¹³ are the groups of R⁸, or —O—R⁸,
m and n, independently of one another, are 1, 2, 3 or 4, and X is an acid which forms adducts with triazine compounds (III).

15. The compression-granulated flame retardant composition as claimed in claim 11, wherein the at least one synergist is zinc oxide, zinc hydroxide, zinc oxide hydrate, anhydrous zinc carbonate, basic zinc carbonate, zinc hydroxide carbonate, basic zinc carbonate hydrate, (basic) zinc silicate, zinc hexafluorosilicate, zinc stannate, zinc magnesium aluminum hydroxide carbonate, zinc hexafluorosilicate hexahydrate, zinc salts of the oxo acids of the third main group, zinc salts of the oxo acids of the fifth main group, zinc pyrophosphate, zinc salts of the oxo acids of the transition metals, zinc chromite, zinc molybdate, zinc permanganate, zinc molybdate magnesium silicate, or zinc permanganate.

16. The compression-granulated flame retardant composition as claimed in claim 11, wherein the at least one synergist has an organic anion.

17. The compression-granulated flame retardant composition as claimed in claim 1, further comprising at least one compound selected from the group consisting of carbodiimides, N,N′-dicyclohexylcarbodiimide, polyisocyanates, carbonylbiscaprolactam, styrene-acrylic polymers, sterically hindered phenols, sterically hindered amines, light stabilizers, phosphonites, antioxidants, and release agents.

18. The compression-granulated flame retardant composition as claimed in claim 1, having an average particle size from 100 to 2000 μm.

19. The compression-granulated flame retardant composition as claimed in claim 1, having an average bulk density from 200 to 1500 g/l.

20. The compression-granulated flame retardant composition as claimed in claim 1, having a dust content from 0.1 to 10% by weight, wherein the dust content is the fraction of flame retardant composition having a particle size below 20 μm.

21. The compression-granulated flame retardant composition as claimed in claim 1, having a phosphorus content from 8 to 50% by weight.

22. The compression-granulated flame retardant composition as claimed in claim 1 comprising
a) from 50 to 98% by weight of the phosphinic salt of the formula (I), the diphosphinic salt of the formula (II), the polymer of the phosphinic salt, the polymer of the diphosphinic salt or a mixture thereof, and
b) from 2 to 50% by weight of the at least one fusible zinc compound.

23. The compression-granulated flame retardant composition as claimed in claim 1, comprising:
a) from 95 to 60% by weight of the phosphinic salt of the formula (I), the diphosphinic salt of the formula (II), the polymer of the phosphinic salt, the polymer of the diphosphinic salt or a mixture thereof, and
b) from 5 to 40% by weight of the at least one fusible zinc compound.

24. The compression-granulated flame retardant composition as claimed in claim 1, comprising:
a) from 8 to 90% by weight of the phosphinic salt of the formula (I), the diphosphinic salt of the formula (II), the polymer of the phosphinic salt, the polymer of the diphosphinic salt or a mixture thereof, and
b) from 2 to 50% by weight of the at least one fusible zinc compound, and
c) from 8 to 90% by weight of at least one synergist.

25. The compression-granulated flame retardant composition as claimed in claim 1, comprising:
a) from 10 to 85% by weight of the phosphinic salt of the formula (I), the diphosphinic salt of the formula (II), the polymer of the phosphinic salt, the polymer of the diphosphinic salt or a mixture thereof, and
b) from 5 to 40% by weight of the at least one fusible zinc compound, and
c) from 10 to 85% by weight of at least one synergist.

26. A process for preparation of a compression-granulated flame retardant composition as claimed in claim 1, comprising the steps of mixing the phosphinic salt of the formula (I), the diphosphinic salt of the formula (II), the polymer of the phosphinic salt, the polymer of the diphosphinic salt or a mixture thereof with the at least one fusible zinc compound at from 50 to 300° C. for from 0.01 to 1 hour to form a mixture, and compacting the mixture to give the compression-granulated material.

27. A flame-retardant polymer molding composition comprising
from 1 to 50% by weight of a compression-granulated flame retardant composition as claimed in claim 1, and
from 1 to 99% by weight of polymer or a mixture of polymers.

28. A flame-retardant polymer molding composition comprising
from 1 to 50% by weight of a compression-granulated flame retardant composition as claimed in claim 1,
from 1 to 99% by weight of polymer or a mixture of polymers,
from 0.1 to 60% by weight of at least one additive, and
from 0.1 to 60% by weight of at least one of a filler or reinforcing material.

29. A flame-retardant polymer molding composition comprising
from 5 to 30% by weight of a compression-granulated flame retardant composition as claimed in claim 1,
from 5 to 90% by weight of polymer of a mixture of polymers,
from 5 to 40% by weight of at least one additive,
from 5 to 40% by weight of at least one of a filler or reinforcing material.

30. The molding composition as claimed in claim 27, wherein the polymer or mixture of polymers is selected from the group consisting of thermoplastic polymers and thermoset polymers.

31. A flame-retardant polymer article comprising
from 1 to 70% by weight of a compression-granulated flame retardant composition as claimed in claim 1, and
from 1 to 99% by weight of polymer or a mixture of polymers,
wherein the polymer article is a polymer molding, polymer film, polymer filament, or polymer fiber.

32. A flame-retardant polymer article comprising
from 1 to 70% by weight of a compression-granulated flame retardant composition as claimed in claim 1,
from 1 to 99% by weight of a polymer or a mixture of polymers,
from 0.1 to 60% by weight of at least one additive, and
from 0.1 to 60% by weight of at least one of a filler or reinforcing material, wherein,
the polymer article is in the form of a polymer molding, polymer film, polymer filament or polymer fiber.

33. A flame-retardant polymer article comprising the flame-retardant polymer molding composition as claimed in claim 27, wherein the polymer article is a polymer molding, polymer film, polymer filament, or polymer fiber.

34. The polymer article as claimed in claim 33, comprising
from 50 to 99% by weight of flame-retardant polymer molding composition.

35. The polymer article as claimed in claim 33, comprising
from 70 to 95% by weight of flame-retardant polymer molding composition.

36. The flame-retardant polymer article as claimed in claim 33, wherein the polymer or mixture of polymers are derived from polybutylene terephthalates, and the modulus of elasticity of the flame-retardant polymer molding, the flame-retardant polymer film, the flame-retardant polymer filament or the flame-retardant polymer fiber is from 10 000 to 12 000 MPa.

37. The flame retardant polymer article as claimed in claim 33, wherein the polymer or mixture of polymers are derived from nylon-6,6 polymers, and the modulus of elasticity of the flame-retardant polymer molding, the flame-retardant polymer film, the flame-retardant polymer filament or the flame-retardant polymer fiber is from 10 000 to 12 000 MPa.

38. The flame-retardant polymer article as claimed in claim 33, wherein the polymer or mixture of polymers are derived from nylon-6 polymers, and the modulus of elasticity of the flame-retardant polymer molding, the flame-retardant polymer film, the flame-retardant polymer filament or the flame-retardant polymer fiber is from 10 000 to 12 000 MPa.

39. The compression-granulated flame retardant composition as claimed in claim 1, wherein the at least one fusible zinc compound has a phosphorus content of from 15 to 25% by weight.

40. The compression-granulated flame retardant composition as claimed in claim 16, wherein the at least one synergist is a zinc salt of mono-, di-, oligo-, or polycarboxylic acid.

41. The compression-granulated flame retardant composition as claimed in claim 40, wherein the zinc salt of mono-, di-, oligo-, or polycarboxylic acid is a salt of formic acid, a salt of acetic acid, a salt of trifluoroacetic acid, zinc propionate, zinc butyrate, zinc valerate, zinc caprylate, zinc oleate, zinc stearate, a salt of oxalic acid, a salt of tartaric acid, a salt of citric acid, a salt of benzoic acid, zinc salicylate, a salt of lactic acid, a salt of acrylic acid, a salt of maleic acid, a salt of succinic acid, a salt of amino acids, a salt of acidic hydroxy functions, zinc para-phenolsulfonate, zinc para-phenolsulfonate hydrate, zinc acetylacetonate hydrate, zinc tannate, zinc dimethyldithiocarbamate, or zinc trifluoromethanesulfonate.

42. The compression-granulated flame retardant composition as claimed in claim 1, having an average particle size from 200 to 1000 μm.

43. The compression-granulated flame retardant composition as claimed in claim 1, having an average bulk density from 300 to 1000 g/l.

44. The compression-granulated flame retardant composition as claimed in claim 1, having a dust content from 0.5 to 5% by weight, wherein the dust content is the fraction of flame retardant composition having a particle size below 20 μm.

45. The compression-granulated flame retardant composition as claimed in claim 1, having a phosphorus content from 15.5 to 40% by weight.

46. The compression-granulated flame retardant composition as claimed in claim 1, having a phosphorus content from 16 to 25% by weight.

47. The process as claimed in claim 26, wherein the mixing step includes mixing at least one synergist with the phosphinic salt of the formula (I), the diphosphinic salt of the formula (II), the polymer of the phosphinic salt, the polymer of the diphosphinic salt or a mixture thereof and the at least one fusible zinc compound
